(19) United States
(12) Patent Application Publication
(10) Pub. No.: US 2024/0140383 A1
(43) Pub. Date: May 2, 2024

(54) BRAKE ACTUATING DEVICE FOR A MOTOR VEHICLE BRAKE SYSTEM HAVING AN ADAPTER UNIT

(71) Applicant: Continental Automotive Technologies GmbH, Hannover (DE)

(72) Inventors: Rüdiger Briesewitz, Bruchkoebel (DE); Johannes Singer, Kassel (DE); Constantin-Petrica Cazacu, Liteni (RO); Constantin-Cosmin Avacaritei, Targu-Neamt (RO)

(73) Assignee: Continental Automotive Technologies GmbH, Hannover (DE)

(21) Appl. No.: 18/493,829

(22) Filed: Oct. 25, 2023

(30) Foreign Application Priority Data
Oct. 26, 2022 (EP) 22465562.1
Nov. 4, 2022 (DE) 10 2022 211 646.1

(51) Int. Cl. B60T 13/14

(52) U.S. Cl. CPC B60T 13/148; B60T 13/686

(57) ABSTRACT

A brake actuating device for a motor vehicle brake system comprising a hydraulic unit has a side face, on which an electric motor is arranged. The electric motor drives a pressure generator, located in the hydraulic unit, for conveying a hydraulic fluid. The hydraulic unit comprises a first plurality of location openings in the side face. An adapter unit having a first connecting surface is arranged on the side face of the hydraulic unit. The adapter unit comprises a second plurality of location openings in the first connecting surface, wherein each of the first plurality of the location openings of the hydraulic unit is connected in fluid communication with one of the second plurality of connection openings of the adapter unit. The adapter unit comprises a second connection surface having a plurality of connection openings for fluidically connecting wheel brakes of the motor vehicle brake system.

### TECHNICAL FIELD

The invention relates to a brake actuating device for a motor vehicle brake system.

### BACKGROUND

DE 10 2018 214 565 A1 discloses a brake actuating device of a motor vehicle brake system, which comprises a block-type hydraulic unit, on which an electric motor and an electronic unit are arranged. The electric motor drives a pressure generator, located in the hydraulic unit, in order to convey a hydraulic fluid under pressure in the direction of the wheel brakes of the motor vehicle brake system. To store the hydraulic fluid, a pressure medium reservoir is arranged directly on the hydraulic unit. The hydraulic unit contains electromagnetic switching valves, which are switched by means of corresponding solenoids in the electronic unit. The electronic unit serves to exercise open-loop and closed-loop control over the brake actuating device.

A multiplicity of channels is drilled into the hydraulic unit, connecting the individual components of the motor vehicle brake system to one another and being connected to or disconnected from one another by means of the switching valves. Four such channels open on an outer side of the hydraulic unit into connection openings, which are provided for the connection of brake lines to the wheel brakes of the motor vehicle brake system. In the brake actuating device these connections are arranged above the electric motor. When this brake actuating device is fastened on one side to the vehicle bulkhead, the connections point to the other side into the engine compartment. Under certain installation conditions, these connections can be difficult to access to connect the wheel brake lines.

DE 103 13 708 A1 discloses a pressure sensor module for electrohydraulic brake systems, which comprises a sensor housing with pressure sensors, wherein the sensor housing is connected to a hydraulic housing, wherein the sensor housing and the hydraulic housing comprise hydraulically connected pressure channels, wherein a connecting element, which is arranged between the flange surface of the sensor housing and the hydraulic housing, is inserted in each of the fluidically communicating pressure channels.

DE 10 2007 052 504 A1 discloses an electrohydraulic drive unit, which has a mounting body, on which an electronic unit and an electric motor situated opposite the electronic unit are arranged, wherein the mounting body comprises internal pressure sources and hydraulic valves, wherein an adapter body is plugged onto the mounting body using a flat seal and is hydraulically connected thereto, wherein connections for piston-cylinder units provided for actuating a movable body component, such as a convertible top, are attached to the adapter body.

### SUMMARY

A brake actuating device for a motor vehicle brake system in which the connection of brake lines is simplified is provided.

A brake actuating device for a motor vehicle brake system comprising a hydraulic unit has a side face, on which an electric motor is arranged. The electric motor drives a pressure generator, located in the hydraulic unit, for conveying a hydraulic fluid. The hydraulic unit comprises a first plurality of location openings in the side face. An adapter unit having a first connecting surface is arranged on the side face of the hydraulic unit. The adapter unit comprises a second plurality of location openings in the first connecting surface, wherein each of the first plurality of the location openings of the hydraulic unit is connected in fluid communication with one of the second plurality of connection openings of the adapter unit. The adapter unit comprises a second connection surface having a plurality of connection openings for fluidically connecting wheel brakes of the motor vehicle brake system.

The brake actuating device may be a modular electrohydraulic brake actuating device.

The modular electrohydraulic brake actuating device may be used in a slip-controlled motor vehicle brake system.

Embodiments will be found in the dependent claims and the following description of an exemplary embodiment with reference to the figures.

### BRIEF DESCRIPTION OF THE DRAWINGS

In the drawings:

FIG. 1 shows an exemplary brake actuating device having an adapter unit;

FIG. 2 shows the adapter unit in a first perspective view;

FIG. 3 shows the adapter unit in a second perspective view;

FIG. 4 shows the adapter unit with a connecting piece to be inserted;

FIG. 5 shows the adapter unit with the connecting piece inserted; and

FIG. 6 shows the adapter unit with the inserted connecting piece in the assembly direction.

### DETAILED DESCRIPTION

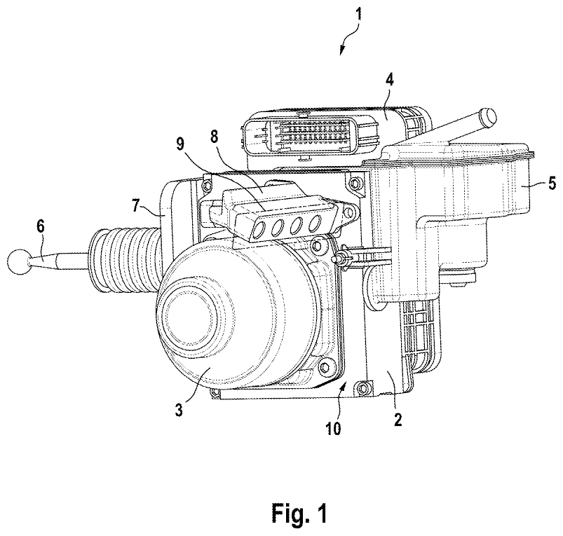

FIG. 1 shows an electrohydraulic brake actuating device 1 for a motor vehicle brake system having a central hydraulic unit 2. An electric motor 3 is attached to a side face 10 of hydraulic unit 2. Electric motor 3 drives a pressure generator arranged in hydraulic unit 2, which pressure generator conveys a hydraulic fluid in the direction of wheel brakes of the motor vehicle brake system. The pressure generator can be designed as a double-stage piston pump or as a linear actuator. To supply the hydraulic fluid, a pressure medium reservoir 5 is attached to hydraulic unit 2.

An electronic unit 4 is arranged on hydraulic unit 2 on the side opposite the electric motor 3. Electronic unit 4 serves to exercise open-loop and closed-loop control over brake actuating device 1. Within hydraulic unit 2 there are electromagnetically actuable switching valves, which are driven by solenoids of the electronic unit 4. The switching valves are used to control the flow of fluid between the individual components of the motor vehicle brake system. Thus, a multiplicity of channels is drilled within hydraulic unit 2, connecting the individual components of the motor vehicle brake system to one another. Four of these channels open into respective location openings on side face 10 of hydraulic unit 2.

According to the example, an adapter unit 8 is attached to side face 10 of hydraulic unit 2. According to the example, adapter unit 8 comprises four connection openings 9 for brake lines, which lead to the wheel brakes of the motor vehicle brake system. To connect these connection openings 9 to hydraulic unit 2, adapter unit 8 comprises a connecting surface, in which four location openings are provided. The location openings of adapter unit 8 are oriented so as to correspond to the location openings of hydraulic unit 2, and therefore there is a fluidic connection here. By means of adapter unit 8 according to the example, connection openings 9 for the wheel brake lines are relocated to a more accessible position in the engine compartment. To connect the brake lines to brake actuating device 1. Adapter unit 8 creates the possibility of the modular principle, and it is therefore possible to use a conventional hydraulic unit 2 for brake actuating device 1. In the applications in which access to the connection openings for the wheel brake lines is made more difficult, additionally attached adapter unit 8 is used. This increases flexibility in the installation of brake actuating device 1 in a motor vehicle.

Also provided on hydraulic unit 2 is a flange 7, by means of which brake actuating device 1 is attached to a fastening point in the motor vehicle, wherein a piston rod 6 projecting from flange 7 leads into the vehicle interior for actuation by a pedal.

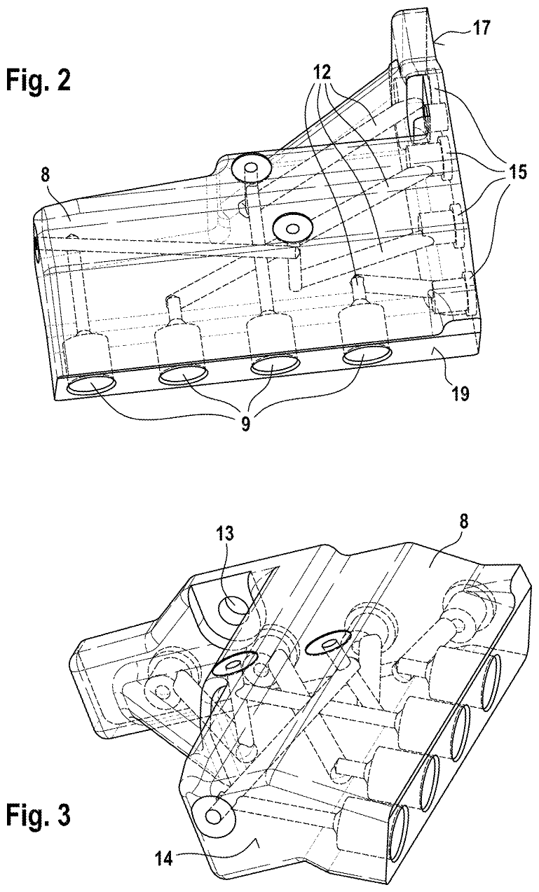

FIG. 2 shows adapter unit 8 in a phantom view. It shows connection surface 19 with the four connection openings 9. The four location openings 15 are situated in a connecting surface 17 oriented at right angles to the connection surface 19. Location openings 15 are connected to connection openings 9 via respective channels 12. Channels 12 are drilled into the metallic adapter unit 8 and closed with a plug where necessary. In this way, a fluidic connection is created from the respective location openings 15 to the corresponding connection openings 9.

FIG. 3 illustrates that adapter unit 8 has a fastening opening 13, thus enabling adapter unit 8 to be screwed to the hydraulic unit, for example. For handling of adapter unit 8 during assembly, it has a tool application surface 14.

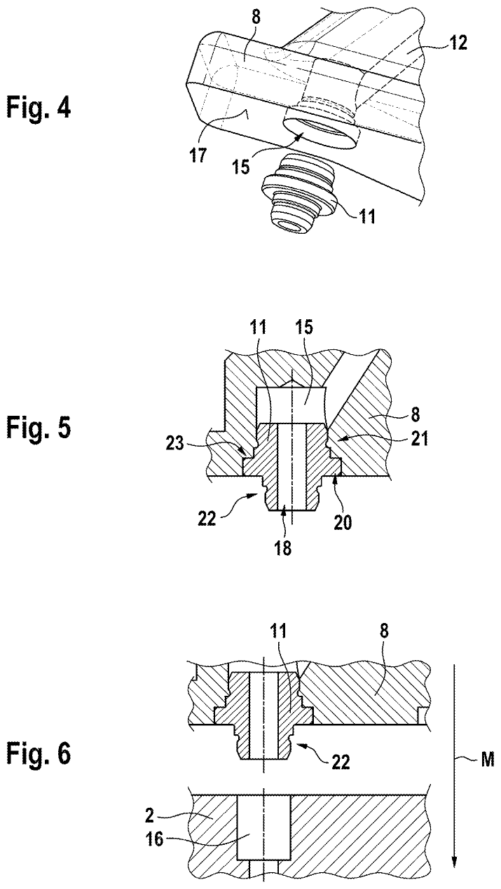

According to the example, a connecting piece is arranged between the location openings of the hydraulic unit and the location openings of the adapter unit. This is illustrated in more detail in FIGS. 4 to 6 below.

FIG. 4 shows connecting piece 11 with adapter unit 8 in an exploded view. Connecting piece 11 is configured to be plugged into a location opening 15 in connecting surface 17 of adapter unit 8. It is also apparent that one of the channels 12 opens into the location opening 15 shown.

FIG. 5 shows a sectional view of adapter unit 8 with location opening 15, within which connecting piece 11 is now partially inserted. Connecting piece 11 has a first conical insertion section 21 with a circumferential groove. Insertion section 21 is press-fitted into location opening 15. To limit insertion, connecting piece 11 comprises a circumferential flange 20, which lies flat in an annular stop 23 of location opening 15. On the other side, connecting piece 11 comprises a smaller-diameter second insertion section 22, which is provided for insertion into the hydraulic unit. To enable the hydraulic fluid to flow from the hydraulic unit into the adapter unit 8, connecting piece 11 has a through hole 18. This type of press-fitting of connecting piece 11 to adapter unit 8 and the hydraulic unit is furthermore pressure-tight, and therefore sealing rings are dispensed with.

Finally, the assembly of adapter unit 8 with hydraulic unit 2 is illustrated in FIG. 6. A connecting piece 11 has already been press-fitted into the location opening of adapter unit 8. Adapter unit 8 then moves toward hydraulic unit 2 in assembly direction M, with the result that second insertion section 22 of connecting piece 11 engages in location opening 16 of hydraulic unit 2 and is press-fitted therewith. FIG. 6 shows only one connecting point. As a rule, four connection openings, each with connecting pieces inserted therein, are located in a row on adapter unit 8. Furthermore, during insertion into the location openings of hydraulic unit 2, self-centering occurs, ensuring that connection of adapter unit 8 to hydraulic unit 2 takes place.

1. A brake actuating device for a motor vehicle brake system comprising:
a hydraulic unit and defining a first plurality of location openings in a side face thereof;
an electric motor arranged on the side face of the hydraulic unit, wherein the electric motor drives a pressure generator located in the hydraulic unit to convey a hydraulic fluid;
an adapter unit having a first connecting surface and defining a second plurality of location openings thereon, wherein the adapter unit is arranged on the side face of the hydraulic unit;
wherein each of the first plurality of location openings of the hydraulic unit is connected in fluid communication with one of the second plurality of location openings of the adapter unit; and
wherein the adapter unit comprises a second connection surface having a plurality of connection openings for fluidically connecting wheel brakes of the motor vehicle brake system.

2. The brake actuating device as claimed in claim 1, further comprising a plurality of connecting pieces, wherein each connecting piece is at least partially inserted into one the first plurality of location opening of the hydraulic unit and at least partially inserted into a corresponding one of the second plurality of location openings of the adapter unit.

3. The brake actuating device as claimed in claim 2, wherein each of the plurality of connecting pieces is pressure-tightly press-fitted into the respective one of the first plurality of the location openings of the hydraulic unit and into the corresponding one of the second plurality of connection openings of the adapter unit.

4. The brake actuating device as claimed in claim 2, wherein each connecting piece comprises a through hole for fluid communication between the hydraulic unit and the adapter unit.

5. The brake actuating device as claimed in claim 1, wherein the adapter unit comprises a plurality of channels, each of which connects one of the second plurality of location openings in the first connecting surface of the adapter unit to one of the plurality of connection openings in the second connection surface of the adapter unit.

6. The brake actuating device as claimed in claim 5, wherein the plurality of channels are drilled into the adapter unit.

7. The brake actuating device as claimed in claim 1, wherein the second connection surface of the adapter unit is oriented at an angle to the side face of the hydraulic unit.

8. The brake actuating device as claimed in 7, wherein the second connection surface is at a right angle to the side face.

9. The brake actuating device as claimed in claim 1, wherein in an installed position of the brake actuating device the adapter unit is arranged above the electric motor on the hydraulic unit.

10. The brake actuating device as claimed in claim 1, wherein the adapter unit is connected to the hydraulic unit with a screwed connection.
